(19) United States
(12) Patent Application Publication
(10) Pub. No.: US 2019/0222912 A1
(43) Pub. Date: Jul. 18, 2019

(54) AUDIO COMMUNICATION SYSTEM

(71) Applicant: EAOS LLC, Philadelphia, PA (US)

(72) Inventors: Alperen Topay, Pennsauken, NJ (US); Emin Faki, Pennsauken, NJ (US); Jacob Tolle, Philadelphia, PA (US)

(73) Assignee: EAOS LLC, Philadelphia, PA (US)

(21) Appl. No.: 15/872,138

(22) Filed: Jan. 16, 2018

(51) Int. Cl. H04R 1/08; H04R 1/10; H04R 1/04

(52) U.S. Cl. CPC H04R 1/08; H04R 1/1016; H04R 1/1033; H04R 2201/107; H04R 1/04; H04R 2420/07; H04R 1/1041

(57) ABSTRACT

The disclosure relates to a microphone assembly that can be positioned comfortably against the skin of a user and provides improved audio capture during communication over a communication system. The microphone assembly includes a body with a central section having a front surface and a rear surface. The microphone assembly includes first and second wings extending from the central section on opposing sides of the body. The microphone assembly includes a microphone disposed at the rear surface of the central section. The microphone and the rear surface are configured to be positioned against a facial structure of a user.

### BACKGROUND

Communicating with others while participating in an activity necessitating high-speed motion, or while in a windy and/or noisy environment generally results in loss in quality of the audio recorded and received by the listener. Traditional audio communication systems for motorcycle riders include helmets with built-in speakers and a microphone wirelessly connected to, for example, a mobile device. In such systems, a space can exist between the user's ears and the speakers within the helmet. Thus, the faster the rider travels, the more wind interference occurs between the speakers and the ear of the rider, resulting in low quality or loss of audio. Some audio communication systems include one or two headphones, and a microphone suspended at one of the wires associated with the headphones. During activities such as cycling or riding a motorcycle, wind flow and external noise is picked up by the microphone, resulting in excessive noise transmitted to the listener.

For activities necessitating a helmet, such as riding a motorcycle, the traditional microphone can either be suspended outside of the coverage of the helmet or be squeezed between the helmet and the user's face. In addition, traditional headphones generally protrude beyond the plane defined by the ear. When a helmet is worn, traditional headphones create an interference resulting in pressure on the user's ears. Traditional audio communication systems can therefore cause discomfort to the user and provide for subpar audio quality.

### SUMMARY

The disclosure relates to an audio communication system including earbuds connected to respective wires, and a microphone assembly connected to the opposing end of the wires. The microphone assembly can be slid along the wires to adjust the position of the microphone assembly. In some embodiments, the wires can suspend the microphone assembly between the earbuds at substantially chin-level of the user (e.g., directly below the bottom lip of the user). Adjustment of the microphone assembly position along the wires allows for customization of the system for users having different facial structures.

The disclosure further relates to microphone assemblies having a microphone disposed at the rear surface of the microphone assembly body such that the microphone can be in direct contact or immediately adjacent with a facial structure (e.g., chin) of the user. The position of the microphone at the rear surface of the body improves the overall audio intake performance of the system, particularly while the user is in motion. The position of the microphone at the rear surface of the body reduces interference of environmental sounds such as wind noise, engine noise, and/or traffic noise with the speech of the user that is recorded by the microphone, thereby allowing for a clearer communication experience. The disclosure further relates to microphone assemblies having first and second wings extending at an angle from a central section of the body of the microphone assemblies. The angled wings provide a profile that sits comfortably against the skin of the user.

In accordance with some embodiments of the present disclosure, an exemplary microphone assembly is provided. The microphone assembly comprises a body, a first wing, a second wing, and a microphone. The body comprises a central section with a front surface and a rear surface. The first wing extends from the central section on one side of the body, and the second wing extends from the central section on an opposing side of the body. The microphone can be disposed at the rear surface of the central section. The microphone and the rear surface can be configured to be positioned against or immediately adjacent to a facial structure of a user.

In some embodiments, the facial structure of the user can be a chin. The microphone assembly can comprise ribs protruding from the central section at the rear surface of the body and at least partially surrounding the microphone. In some embodiments, each of the ribs can define a substantially semicircular configuration partially surrounding the microphone. In some embodiments, a protrusion height of the microphone from the rear surface of the central section can be dimensioned substantially equal to a protrusion height of the ribs protruding from the central section. In some embodiments, a protrusion height of the microphone from the rear surface of the central section can be dimensioned substantially smaller than a protrusion height of the ribs protruding from the central section.

The microphone assembly comprises an actuator assembly (e.g., buttons) coupled to the front surface of the central section. The actuator assembly can comprise a first button extending around the front surface of the central section, around a bottom edge of the central section, and along a bottom surface of the central section. In some embodiments, the first and second wings each comprise an opening extending from a rear surface to a front surface of the respective first and second wings. The first and second wings can each comprise a groove connected to the respective opening and extending along the front surface of the first and second wings. In some embodiments, the first and second wings can each comprise wire clips disposed on opposing sides of the groove and configured to detachably secure earbud wires.

In accordance with embodiments of the present disclosure, an exemplary microphone assembly is provided. The microphone assembly comprises a body, a first wing, a second wing, and a microphone. The body comprises a central section extending along a first plane. The first wing extends from the central section on one side of the body. The first wing extends along a second plane radially offset from the first plane by a first angle. The second wing extends from the central section on an opposing side of the body. The second wing extends along a third plane radially offset from the first plane by a second angle. The microphone can be disposed on the body.

In some embodiments, the first angle and the second angle can be, e.g., from approximately 15 degrees to approximately 60 degrees, from approximately 25 degrees to approximately 50 degrees, from approximately 30 degrees to approximately 45 degrees, from approximately 35 degrees to approximately 40 degrees, or the like. In some embodiments, the first angle and the second angle can be approximately 37 degrees. In some embodiments, the microphone can be disposed at a rear surface of the body and configured to be positioned against a facial structure of a user. In some embodiments, the microphone can be disposed at a top edge of the body and configured to be spaced from a facial structure of a user. The microphone assembly can comprise ribs protruding from the central section at the rear surface of the body and surrounding the microphone.

In accordance with embodiments of the present disclosure, an exemplary audio communication system is provided. The system comprises first and second earbuds, and a microphone assembly. The first earbud can be connected to a first wire, and the second earbud can be connected to a second wire. The microphone assembly can be connected to the first and second wires. The first and second wires can be capable of suspending the microphone assembly between the first and second earbuds at chin-level of a user. In some embodiments, the microphone assembly can be slidably engaged with the first and second wires. The system can comprise a controller (e.g., a remote control device) communicatively coupled to the microphone assembly. The controller allows the user to control audio (e.g., play, pause, volume control, track selection, or the like) and call features (e.g., start call, end call, push to talk, or the like). The controller comprises a ratchet locking mechanism for detachably locking the controller to a handlebar.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed audio communication system, reference is made to the accompanying figures, wherein:

FIG. 1 is a front view of an exemplary audio communication system of the present disclosure;

FIG. 2 is a rear view of an exemplary audio communication system of the present disclosure;

FIG. 3 is a front perspective view of a microphone assembly of an exemplary audio communication system of the present disclosure;

FIG. 4 is a rear perspective view of a microphone assembly of an exemplary audio communication system of the present disclosure;

FIG. 5 is a top view of a microphone assembly of an exemplary audio communication system of the present disclosure;

FIG. 6 is a rear view of a microphone assembly of an exemplary audio communication system of the present disclosure;

FIG. 7 is an exploded view of a microphone assembly of an exemplary audio communication system of the present disclosure;

FIG. 8 is a front perspective view of a microphone assembly of an exemplary audio communication system of the present disclosure, including earbud wires;

FIGS. 9A and 9B are front and bottom views of a microphone assembly of an exemplary audio communication system of the present disclosure, without earbud wire clips;

FIGS. 10A and 10B are front and bottom views of a microphone assembly of an exemplary audio communication system of the present disclosure, including earbud wire clips;

FIG. 11 is a rear perspective view of a microphone assembly of an exemplary audio communication system of the present disclosure, including a microphone at a top edge of a body;

FIG. 12 is a top view of a microphone assembly of an exemplary audio communication system of the present disclosure, including a microphone recessed relative to surrounding ribs;

FIGS. 13A and 13B are rear and top views of a microphone assembly of an exemplary audio communication system of the present disclosure, including triangular, vertically oriented ribs;

FIGS. 14A and 14B are rear and top views of a microphone assembly of an exemplary audio communication system of the present disclosure, including linear, vertically oriented ribs;

FIGS. 15A and 15B are rear and top views of a microphone assembly of an exemplary audio communication system of the present disclosure, including hexagonal ribs;

FIGS. 16A and 16B are rear and top views of a microphone assembly of an exemplary audio communication system of the present disclosure, including curved, vertically oriented ribs;

FIG. 17 is a front perspective view of a right earbud of an exemplary audio communication system of the present disclosure;

FIG. 18 is a side view of a right earbud of an exemplary audio communication system of the present disclosure;

FIG. 19 is a front view of a right earbud of an exemplary audio communication system of the present disclosure;

FIG. 20 is an exploded view of a right earbud of an exemplary audio communication system of the present disclosure;

FIG. 21 is a front view of an exemplary audio communication system of the present disclosure, including a microphone assembly worn at chin level;

FIG. 22 is a side view of an exemplary audio communication system of the present disclosure, including a microphone assembly worn at chin level below a helmet;

FIG. 23 is a side view of an exemplary audio communication system of the present disclosure, including a microphone assembly worn at an upper chin level;

FIG. 24 is a side view of an exemplary audio communication system of the present disclosure, including a microphone assembly worn at a lower chin level;

FIG. 25 is a side view of an exemplary audio communication system of the present disclosure, including a microphone assembly worn below a chin level;

FIG. 26 is a rear perspective view of a controller of an exemplary audio communication system of the present disclosure;

FIG. 27 is a side view of a controller of an exemplary audio communication system of the present disclosure;

FIG. 28 is a front view of a controller of an exemplary audio communication system of the present disclosure;

FIG. 29 is a front perspective view of a controller of an exemplary audio communication system of the present disclosure mounted to a handlebar;

FIG. 30 is a block diagram of an exemplary audio communication system of the present disclosure;

FIG. 31 is a block diagram of a computing device of the present disclosure; and

FIG. 32 is a block diagram of an exemplary audio communication system environment of the present disclosure.

### DETAILED DESCRIPTION

Various terms relating to the methods and other aspects of the present disclosure are used throughout the specification and claims. Such terms are to be given their ordinary meaning in the art unless otherwise indicated. Other specifically defined terms are to be construed in a manner consistent with the definition provided herein.

As used in this specification and the appended claims, the singular forms “a,” “an,” and “the” include plural referents unless the content clearly dictates otherwise.

The term “more than 2” as used herein is defined as any whole integer greater than the number two, e.g., 3, 4, or 5.

The term “plurality” as used herein is defined as any amount or number greater or more than 1. In some embodiments, the term “plurality” means 2, 3, 4, 5, 6 or more.

The terms “left” or “right” are used herein as a matter of mere convenience, and are determined by standing at the rear of the machine facing in its normal direction of travel. Likewise, “forward” and “rearward” are determined by the normal direction of travel. “Upward” and “downward” orientations are relative to the ground or operating surface as are any references to “horizontal” or “vertical” planes.

The term “about” or “approximately” as used herein when referring to a measurable value such as an amount, a temporal duration, and the like, is meant to encompass variations of ±20%, ±10%, ±5%, ±1%, ±0.5%, ±0.4%, ±0.3%, ±0.2%, ±0.1%, ±0.09%, ±0.08%, ±0.07%, ±0.06%, ±0.05%, ±0.04%, ±0.03%, ±0.02% or ±0.01% from the specified value, as such variations are appropriate to perform the disclosed methods.

The term “microphone” as used herein is defined as any device capable of receiving as input audio data, and preparing such audio data for transmission to a receiving party (e.g., a listener).

The term “earbud” as used herein is defined as any device to be worn at the ear(s) of the user, and capable of providing as output audio data received from a transmitting party (e.g., a party participating in a telephone conversation with the user).

The term “controller” as used herein is defined as device remote from the microphone and earbuds, and communicatively coupled to the microphone and earbuds (wired and/or wirelessly), the device capable of providing at least partial control of the microphone and/or earbuds of the user.

The term “audio communication system” as used herein is defined as any type of hardware and/or software capable of providing audio communication for a user. For example, the audio communication system can include a headset with earbuds and a microphone. As a further example, the audio communication system can include the headset with the controller (e.g., remote control device).

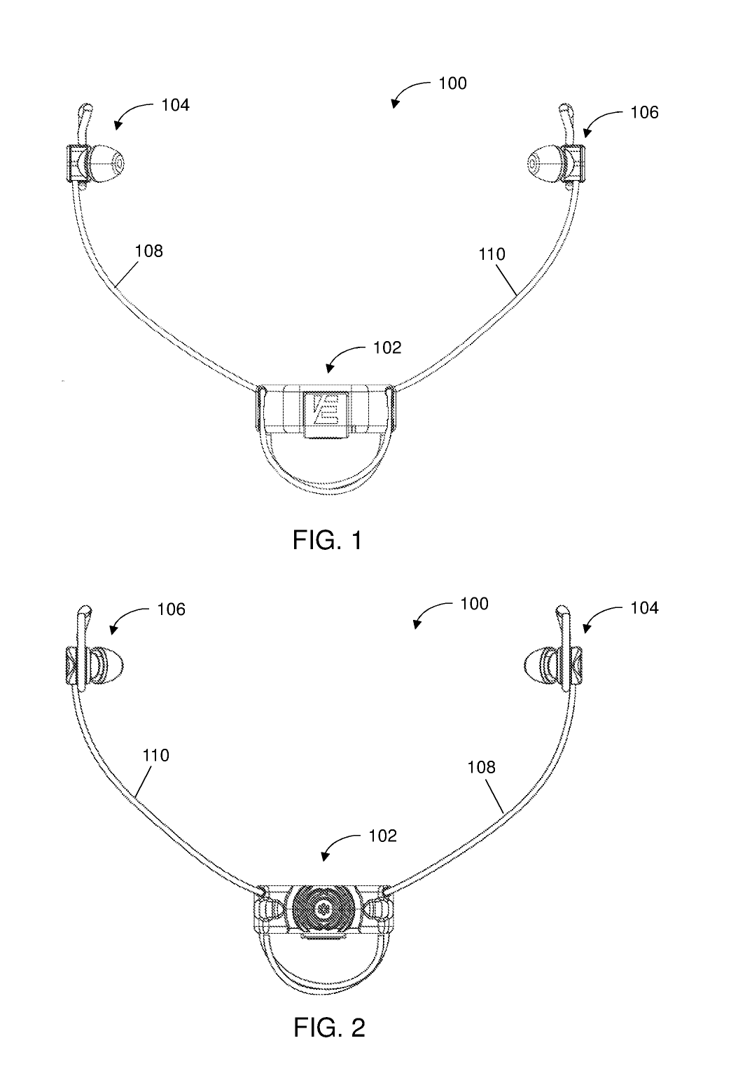

FIGS. 1 and 2 show front and rear views of an exemplary audio communication system 100 (hereinafter “system 100”) of the present disclosure. The system 100 includes a microphone assembly 102 and earbuds 104, 106 coupled with and communicatively connected to the microphone assembly 102 by respective earbud wires 108, 110. The wires 108, 110 provide the wired communication between the microphone assembly 102 and the earbuds 104, 106. The microphone assembly 102, in turn, can be communicatively connected to a user device (e.g., a mobile device). When connected with the user device, the system 100 allows for the user to hear audio through the earbuds 104, 106, and correspond with individuals on a telephone call via the microphone assembly 102.

In some embodiments, the connection between the user device and the microphone assembly 102 can be via Bluetooth or any other wireless communication. As will be discussed in greater detail below, the microphone assembly 102 is slidably coupled to the wires 108, 110 such that the position of the microphone assembly 102 along the wires 108, 110 can be adjusted. Particularly, the microphone assembly 102 can be slid along each of the wires 108, 110 independently to adjust each side of the system 100. Such adjustment allows for the system 100 to be used by individuals having different facial structures.

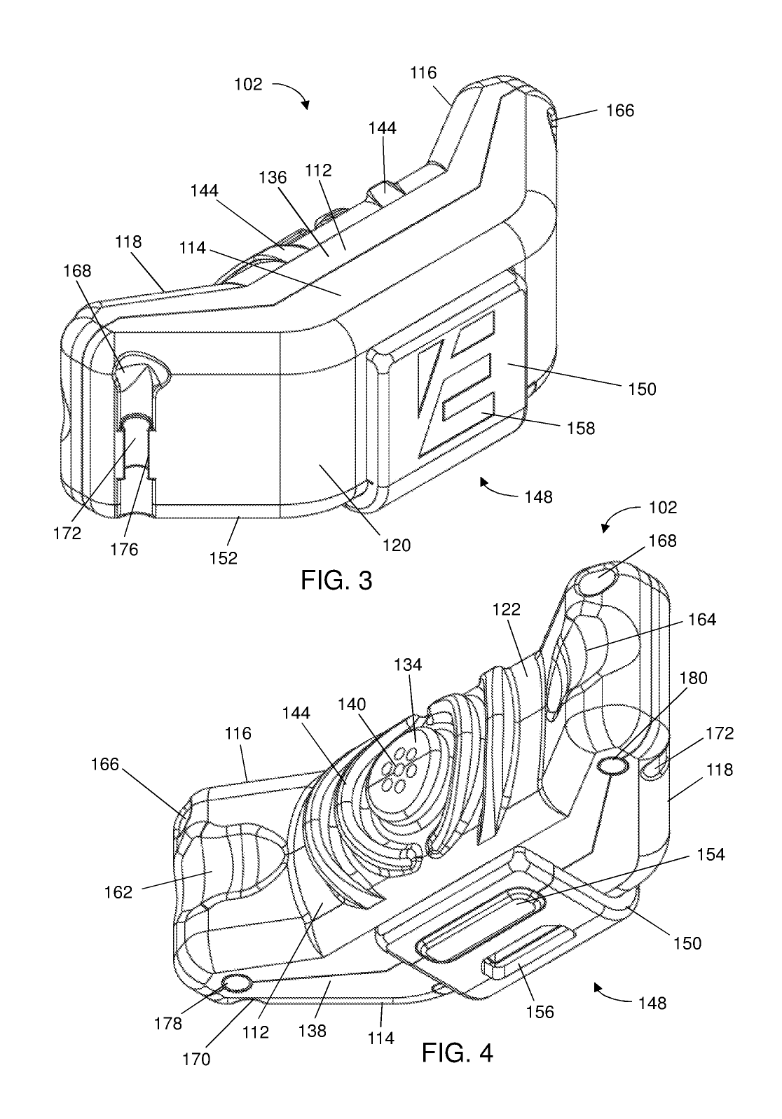

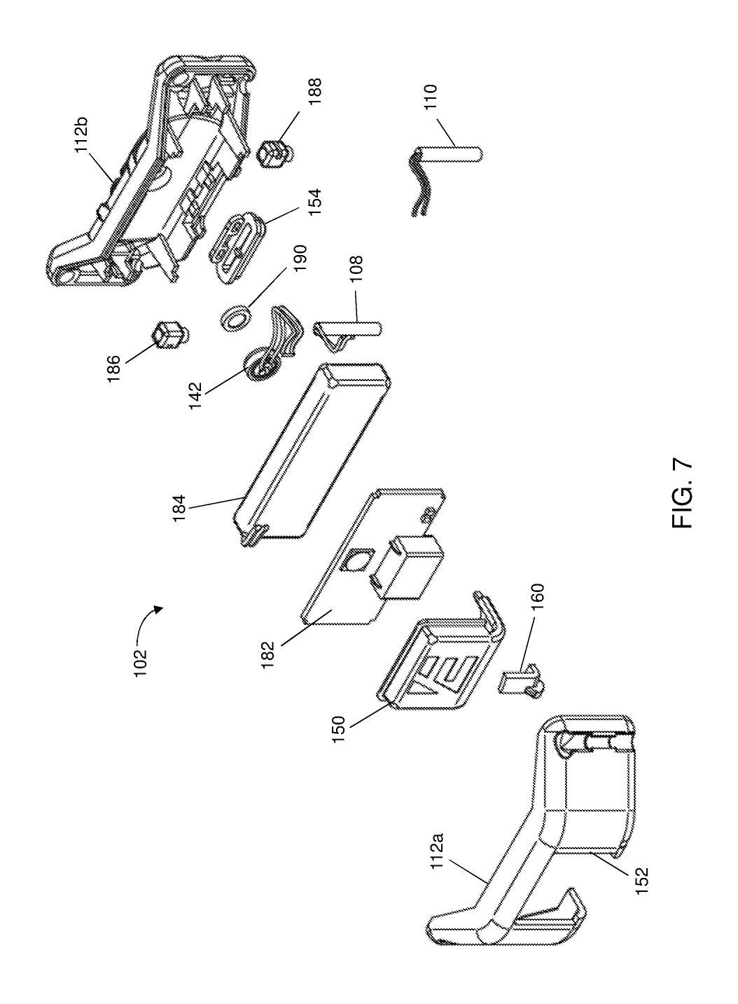

FIGS. 3-7 show perspective, top, rear and exploded views of the exemplary microphone assembly 102. The microphone assembly 102 includes a body 112 including a central section 114, and first and second wings 116, 118 extending from the central section 114. In some embodiments, the body 112 can be formed from a first body half 112a and a second body half 112b configured to be interlocked to house components therebetween (see, e.g., FIG. 7). The central section 114 and the first and second wings 116, 118 can be integrally formed. The body 112 includes a front surface 120 and a rear surface 122. The front surface 120 is configured to be positioned facing away from a facial structure of the user (e.g., away from the chin of the user). The rear surface 122 is configured to be positioned against or immediately adjacent to a facial structure (e.g., the chin) of the user.

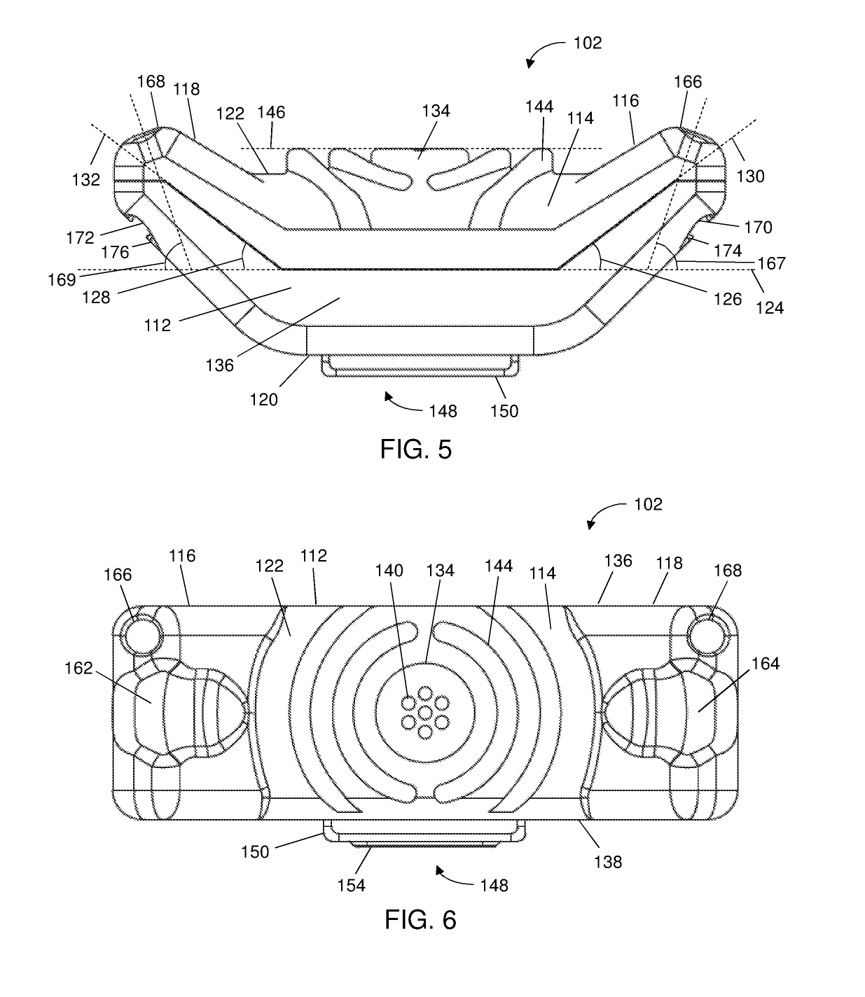

The central section 114 can extend substantially linearly along a first plane 124 (see, e.g., FIG. 5). The first wing 116 extends from the central section 114 on one side of the body 112, and the second wing 118 extends from the central section 114 on the opposing side of the body 112. The first and second wings 116, 118 are each radially offset from the first plane 124 by first and second angles 126, 128, respectively. Particularly, the first and second wings 116, 118 are both rotated away from the plane 124 and extend along respective second and third planes 130, 132 that are angled relative to the first plane 124.

In some embodiments, the first and second angles 126, 128 can be from approximately 15 degrees to approximately 60 degrees. In some embodiments, the first and second angles 126, 128 can be approximately 37 degrees. The curved or angled configuration of the first and second wings 116, 118 provides a surface that mates against and partially wraps around the chin of the user. The angled first and second wings 116, 118 reduce or prevent wind and noise interference from reaching the rear surface 122 of the central section 114.

The microphone assembly 102 includes a microphone 134 disposed at the rear surface 122 of the central section 114. In some embodiments, the microphone 134 can be disposed at the midpoint of the central section 114, between the top and bottom surfaces 136, 138 of the body 112. In some embodiments, the microphone 134 can be disposed anywhere on the rear surface 122 of the microphone assembly 102 (e.g., the central section 114, the wings 116, 118, or the like). The microphone 134 can comprise openings 140 extending through the microphone 134 and into the interior of the body 112. The microphone assembly 102 includes an audio transducer 142 within the body 112 for receiving as input sounds spoken by the user. The microphone 134 (and the audio transducer 142) are therefore positioned at or near the rear surface 122 of the microphone assembly 102, and are configured to be positioned against or immediately adjacent to the chin of the user. The angled wings 116, 118 and the position of the microphone 134 against the chin of the user reduces the amount of wind and noise intrusion collected and transmitted by the microphone 134.

The microphone assembly 102 includes one or more ribs 144 protruding or extending from the rear surface 122 of the central section 114. The ribs 144 are disposed around the microphone 134, with each of the ribs 114 at least partially surrounding the microphone 134. In some embodiments, each of the ribs 114 can define a substantially semicircular configuration. In some embodiments, each of the ribs 114 can at least partially surround respective halves of the microphone 134. The ribs 114 provide surfaces that separate/offset the rear surface 122 from the chin or skin of the user, allowing for airflow or ventilation and reducing sweat build-up. Thus, when the microphone assembly 102 is placed against the chin or skin of the user, additional comfort is provided to the user and prevents interference with the microphone 134.

In some embodiments, a protrusion height of the microphone 134 as measured from the rear surface 122 of the central section 114 can be dimensioned substantially equal to a protrusion height of the ribs 144 protruding from the rear surface 122. In such embodiment, the microphone 134 and the ribs 144 can be substantially aligned along a plane 146. The plane 146 can be substantially parallel to the plane 124 (see, e.g., FIG. 5). In some embodiments, the protrusion height of the microphone 134 can extend above or below the plane 146.

The microphone assembly 102 includes an actuator assembly 148 (e.g., one or more buttons) for controlling operation of the system 100. The actuator assembly 148 can be movably or slidably coupled to the front surface 120 of the central section 114. The actuator assembly 148 includes a primary or first button 150 that extends around the front surface 120 of the central section 114, around a bottom edge 152 of the central section 114, and along the bottom surface 138 of the central section 114. The first button 150 can therefore define a substantially L-shaped configuration. The first button 150 can be configured actuated or depressed by the user to regulate a play/pause function, with the first button 150 sliding along an opening 152 of the first body half 112a (see, e.g., FIG. 7). In some embodiments, pressing the first button 150 two or more times in sequence can initiate a voice activation system (e.g., Ski, or the like). The central location of the first button 150 provides for ease in locating the button 150 during use of the system 100, even if the user is wearing gloves.

The actuator assembly 148 includes a second button 154 disposed at the bottom surface 138 of the central section 114. The second button 154 can be movably actuated or depressed relative to the first button 150. In some embodiments, the second button 154 can allow the user to switch between audio in both earbuds 104, 106, or audio in only one of the two earbuds 104, 106. For safety purposes, the user can thereby select whether both earbuds 104, 106 output audio, or if audio is only output from one of the earbuds 104, 106. The actuator assembly 148 includes a port 156 (e.g., a USB port) configured to connect a wire from an external source to the microphone assembly 102. For example, the port 156 can be used to charge the microphone assembly 102.

In some embodiments, the front surface of the actuator assembly 148 (or first button 150) can comprise a logo 158. In some embodiments, the logo 158 can be in the form of a cutout or can be formed from a transparent material, and the actuator assembly 148 can comprise a light source 160 (see, e.g., FIG. 7). In some embodiments, the light source 160 can be illuminated when the first button 150 (or the second button 154) is depressed to provide a visual indicator to the user confirming actuation of the button 150, 154. In some embodiments, the light source 160 can be configured to illuminate the logo 158 in different colors based on the function performed after actuation of the button 150, 154.

In some embodiments, the first and second wings 116, 118 can each comprise grooves 162, 164 formed in the rear surface 122. The grooves 162, 164 can each define a substantially oval shape and can assist in providing additional airflow at the rear surface 122 of the microphone assembly 102. The grooves 162, 164 and the ribs 144 therefore improve the comfort level of the user when the microphone assembly 102 is positioned against the skin of the user.

The first and second wings 116, 118 each comprise an opening 166, 168 formed therein and extending between the front and rear surfaces 120, 122. The openings 166, 168 are formed at the top corners of the wings 116, 118 and extend at non-90° angles 167, 169 relative to the first plane 124 and the front surface 120 (see, e.g., FIG. 5). In some embodiments, the angles 167, 169 can be between approximately 60° and approximately 85°. The openings 166, 168 can also be angled upwardly when viewed from the rear (see, e.g., FIG. 6). For example, the openings 166, 168 can be positioned further from the top surface 136 at the front surface 120 of the microphone assembly 102, and closer to the top surface 136 at the rear surface 122 of the microphone assembly 102.

Each of the openings 166, 168 receives therethrough a respective earbud wire 108, 110. As will be discussed in greater detail below, the wires 108, 110 can be slid through the openings 166, 168 when adjusting the position of the microphone assembly 102 along the wires 108, 110. The position and angle of the openings 166, 168 at the top corners of the wings 116, 118 allows for gravity and the force from the wires 108, 110 to maintain the position of the microphone assembly 102 at the desired position below the lower lip of the user. Particularly, the position and angle of the openings 166, 168 creates forces on the microphone assembly 102 from the tightened wires 108, 110 that position the microphone assembly 102 against the chin of the user, and prevent the microphone assembly 102 from rotating away from the chin of the user.

The first and second wings 116, 118 each comprise wire grooves 170, 172 formed in and extending along the front surface 120. The wire grooves 170, 172 extend vertically between the top and bottom surfaces 136, 138, and connect at the uppermost portion with the respective openings 166, 168. In some embodiments, the first and second wings 116, 118 comprise wire clips 174, 176 disposed on opposing sides of the wire grooves 170, 172. The wire clips 174, 176 can be in the form of protrusions that extend over the opening of the wire grooves 170, 172, and are configured to provide a snap fit around an earbud wire 108, 110.

In some embodiments, the wire clips 174, 176 extend along the same plane as the front surface 120, and do not extend beyond the front surface 120 of the first and second wings 116, 118. Thus, once the position of the microphone assembly 102 along the wires 108, 110 is determined, the wires 108, 110 can be snapped into the grooves 170, 172 and the wire clips 174, 176 detachably secure the wires 108, 110 until additional adjustment is desired. The first and second wings 116, 118 each comprise openings 178, 180 at the bottom surface 138. The ends of the earbud wires 108, 110 can electrically and fixedly connect to the microphone assembly 102 at the openings 178, 180.

Particularly, with reference to FIG. 7, the microphone assembly 102 can comprise a printed circuit board (PCB) 182, an energy source 184 (e.g., a battery), and wire connectors 186, 188 disposed within the body 112. The wire connectors 186, 188 can extend through the openings 178, 180 to electrically connect with the wires 108, 110. In some embodiments, the microphone assembly 102 can comprise a transducer jack 190 (e.g., silicone, rubber, or the like) between the audio transducer 142 and the microphone 134 to protect the audio transducer 142 and improve water and/or sweat resistance.

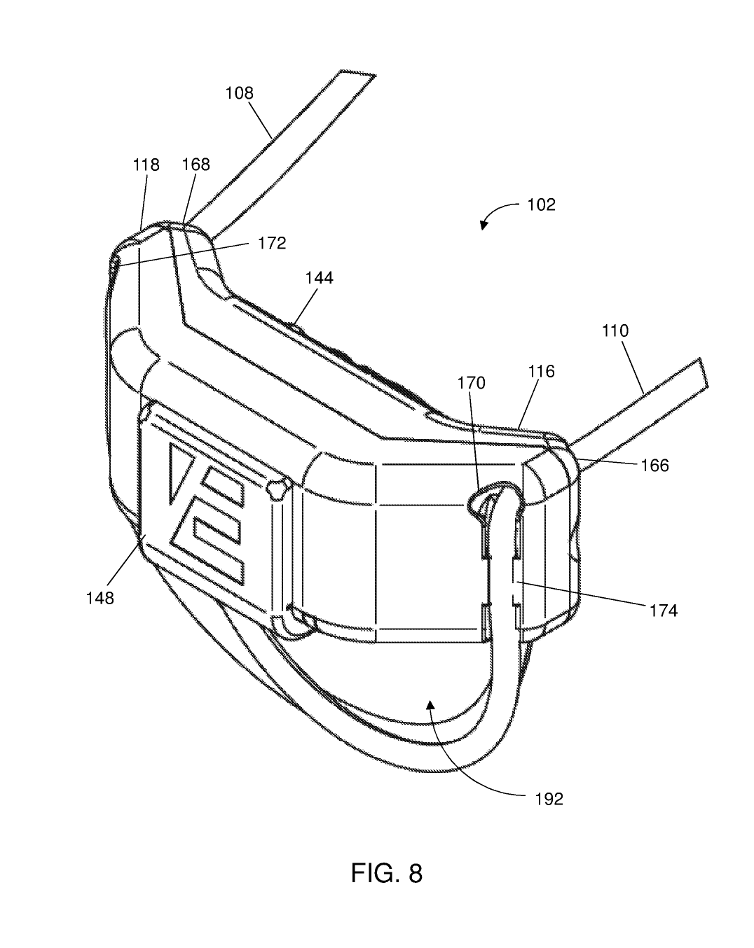

With reference to FIG. 8, the microphone assembly 102 is shown with the earbud wires 108, 110. The wires 108, 110 pass through the respective openings 166, 168 at the corners of the wings 116, 118, crisscross below the microphone assembly 102 (forming loops 192), and electrically couple to the microphone assembly 102 at opposing openings 178, 180. The size of the loops 192 can be varied as the wires 108, 110 are slid through the openings 166, 168 to reposition the microphone assembly 102 along the wires 108, 110. Once the desired position is achieved, the respective wires 108, 110 can be snapped, force or friction fit into the wire grooves 170, 172. The wire clips 174, 176 assist in maintaining the position of the wires 108, 110 until the user decides to readjust the position of the microphone assembly 102.

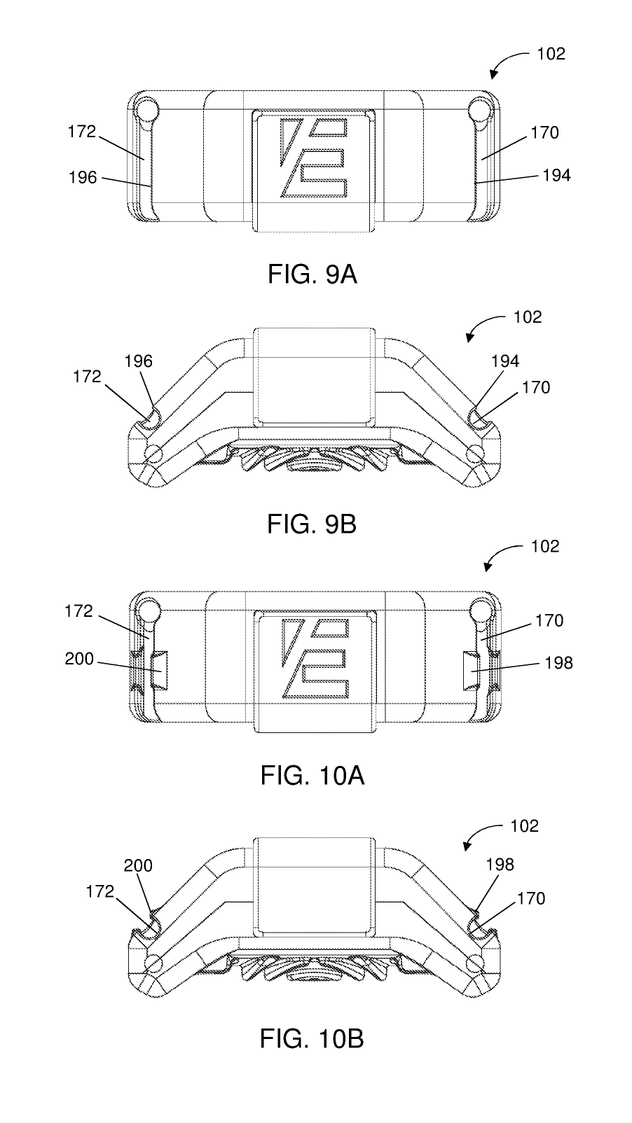

FIGS. 9A and 9B are front and bottom views of the microphone assembly 102 without the earbud clips 174, 176. Particularly, rather than including the clips 174, 176 to maintain the position of the wires 108, 110 within the wire grooves 170, 172, the wire grooves 170, 172 of the microphone assembly 102 can comprise linear edges 194, 196 extending in-line with the plane defined by the front surface 120 of the wings 116, 118. The wires 108, 110 can therefore be maintained within the grooves 170, 172 by friction between the wires 108, 110 and the inner walls of the grooves 170, 172.

FIGS. 10A and 10B are front and bottom views of the microphone assembly 102 with a different configuration of the wire clips 198, 200. Particularly, rather than including clips 174, 176 that extend and are in-line with the plane defined by the front surface 120 of the wings 116, 118, the wire clips 198, 200 extend outwardly from the plane defined by the front surface 120. The wire clips 198, 200 can be in the form of protrusions that extend over the opening of the wire grooves 170, 172, and are configured to provide a snap and friction fit around an earbud wire 108, 110. The distance between the wire clips 198, 200 can be dimensioned smaller than the inner diameter of the wire grooves 170, 172.

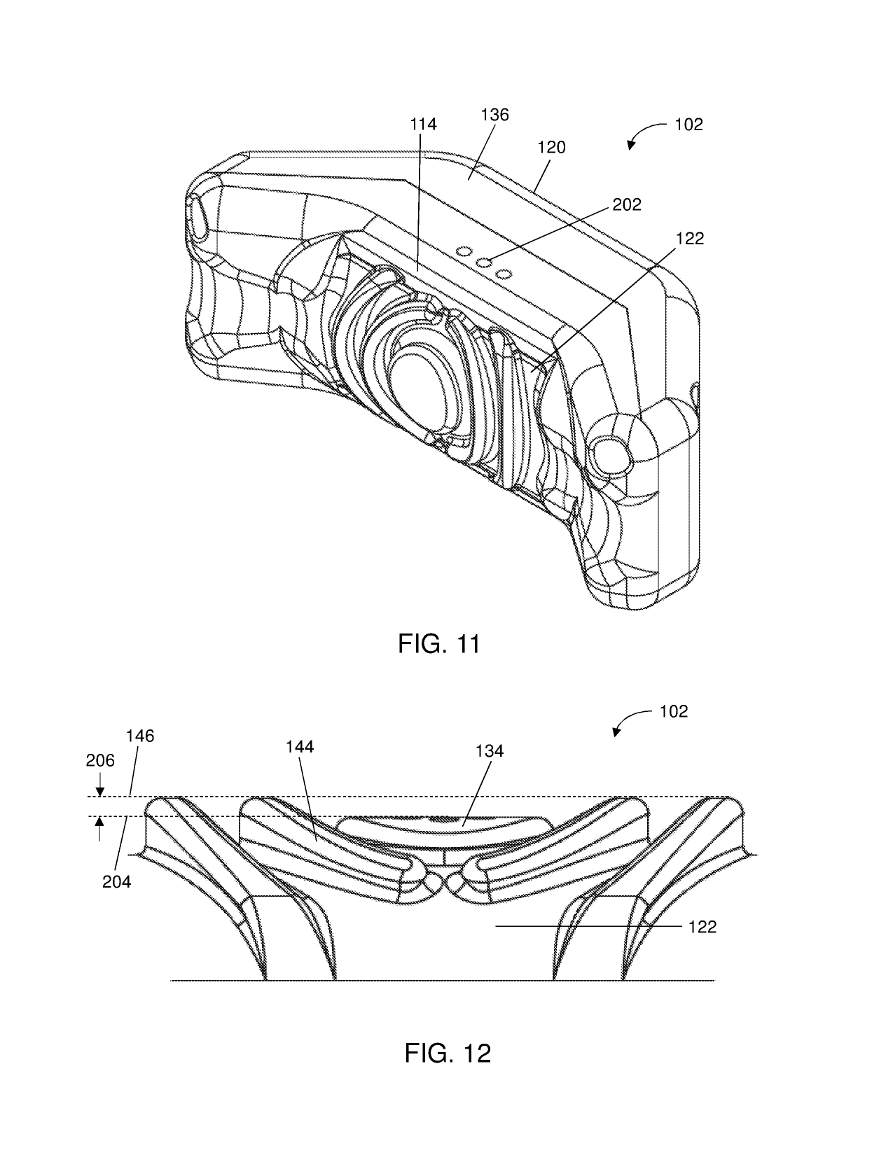

FIG. 11 is a rear perspective view of the microphone assembly 102. In some embodiments, rather than having the microphone 134 at the rear surface 122 of the central section 114, the microphone assembly 102 can comprise a microphone 202 at the top surface 136 of the central section 114. In such position, the microphone 202 can be spaced from the skin of the user when the microphone assembly 102 is placed against the chin. In some embodiments, the microphone 202 can be positioned closer to the rear surface 122 than the front surface 120 to improve overall audio quality and reduce effects of environmental noise on microphone recording quality. In some embodiments, the microphone 202 can be disposed along an edge between the top surface 136 and the rear surface 122 of the central section 114.

FIG. 12 is a top, detailed view of the microphone assembly 102. In some embodiments, the protrusion height of the microphone 134 can be dimensioned smaller than the protrusion height of the ribs 144, as measured from the rear surface 122. Particularly, the plane 204 corresponding with extension of the microphone 134 can be offset from the plane 146 corresponding with extension of the ribs 144 by a distance 206. The offset configuration of the microphone 134 can maintain separation between the skin of the user and the microphone 134, improving overall audio quality in cases where recording may be obstructed due to features on the chin (e.g., beard, chin-strap, or the like). In such embodiments, the protrusions 144 can be disposed against the skin of the user and elevate the microphone 134 over the skin of the user.

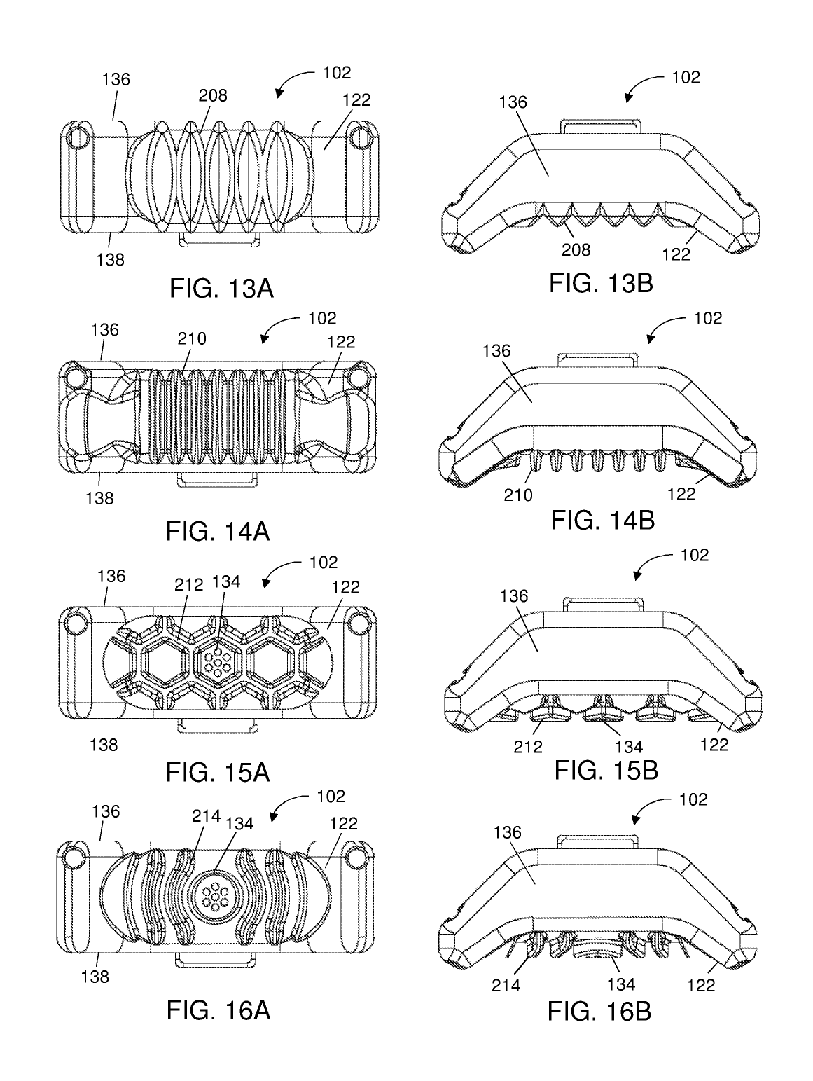

FIGS. 13A and 13B are rear and top views of the microphone assembly 102. In some embodiments, the microphone assembly 102 can comprise ribs 208 that define a substantially triangular, vertically oriented configuration. For example, when viewed from the top, the ribs 208 can define a substantially triangular configuration. When viewed from the rear, the ribs 208 define a point at the top surface 136, gradually increase to a larger width in the middle, and taper back to a point at the bottom surface 136. Although not shown, it should be understood that the microphone 134 can be disposed at the central area of the rear surface 122 or at the top surface 136.

FIGS. 14A and 14B are rear and top views of the microphone assembly 102. In some embodiments, the microphone assembly 102 can comprise ribs 210 that define a substantially linear, vertically-oriented configuration. For example, when viewed from the top, the ribs 210 can define a substantially thin, linear configuration with a thickness substantially similar along the height of the ribs 210. When viewed from the rear, the ribs 210 can comprise curved ends at the top and bottom surfaces 136, 138. Although not shown, it should be understood that the microphone 134 can be disposed at the central area of the rear surface 122 or at the top surface 136.

FIGS. 15A and 15B are rear and top views of the microphone assembly 102. In some embodiments, the microphone assembly 102 can comprise ribs 212 that define a substantially hexagonal configuration. For example, when viewed from the rear, each rib 212 can define a hexagonal configuration with recessed passages in-between. Although the microphone 134 is shown at the rear surface 122, in some embodiments, the microphone 134 can be disposed at the top surface 136.

FIGS. 16A and 16B are rear and top views of the microphone assembly 102. In some embodiments, the microphone assembly 102 can comprise ribs 214 that define a substantially curved, vertically oriented configuration. For example, when viewed from the top, the ribs 214 can define a substantially thin, linear configuration with a thickness substantially similar along the height of the ribs 214. When viewed from the rear, the ribs 214 can curve outwardly around the microphone 134 and curve inwardly near the top and bottom surfaces 136, 138. Although the microphone 134 is shown at the rear surface 122, in some embodiments, the microphone 134 can be disposed at the top surface 136.

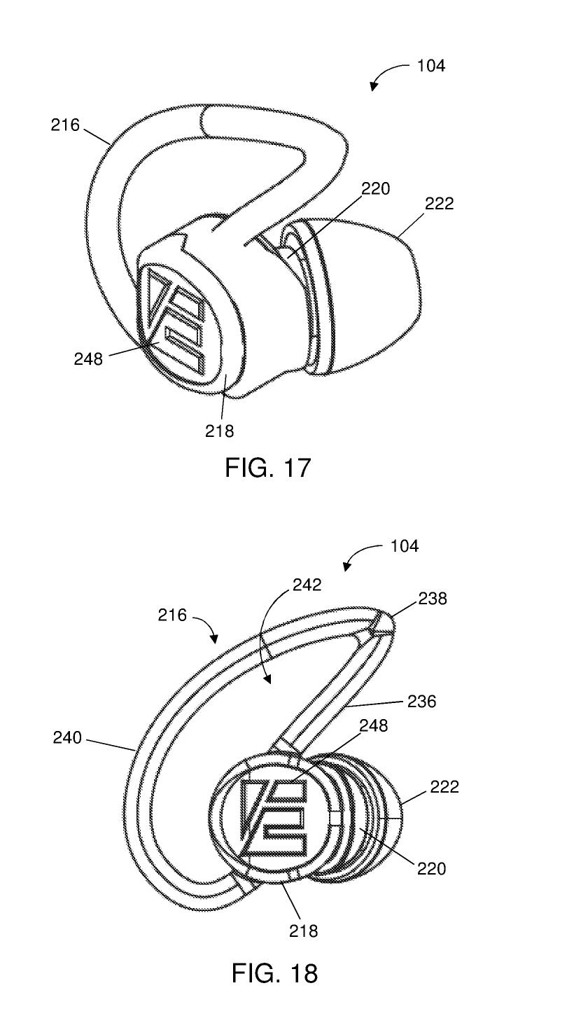

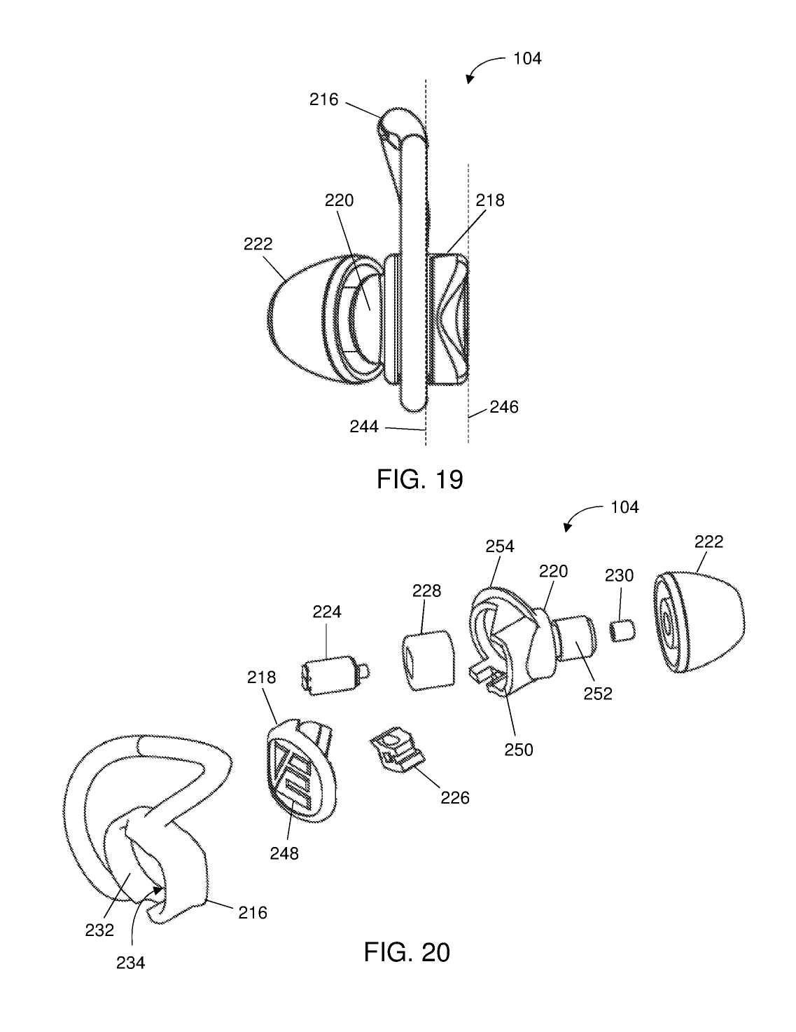

FIGS. 17-20 show perspective, side, front and exploded views of an exemplary right earbud 104 of the present disclosure. Although only the right earbud 104 is discussed herein, it should be understood that the left earbud 106 can be a mirror image of the right earbud 104 and includes the same structural elements. The earbud 104 includes an ear grip 216, a first body half 218, a second body half 220, and an ear tip 222. The earbud 104 includes a driver 224, a cable stopper 226, a drive mount 228, and an acoustic filter 230. The earbud wire 108 can electrically connect with the earbud 104 to provide audio output to the user.

The ear grip 216 includes an earbud cradle 232 with a central opening 234. The ear grip 216 is formed from a flexible band that is capable of being twisted or compressed to insert the ear grip 216 into the antihelix, targus and anti-targus of the ear of the user. The ear grip 216 includes a linear section 236 extending at an angle from the first body half 218 up to a top point 238 (see, e.g., FIG. 18). The ear grip 216 includes a curved section 240 extending from the top point 238 and to the bottom side of the first body half 218.

The ear grip 216 includes a central opening 242 that allows the ear grip 216 to be flexed to fit within ears of different sizes. When placed within the ear of the user, the ear grip 216 can sit medially within a plane 244 defined by the antihelix, targus and anti-targus of the ear. The first body half 218 can also sit within a plane 246 defined by the ear and/or side of the head of the user. Thus, if a helmet is worn by the user of the earbud 104, the earbud 104 does not interfere with the helmet and forces imparted by the helmet on the earbud are reduced.

The first body half 218 can comprise a logo 248 formed in the outer-facing surface. In some embodiments, the earbud 104 can comprise a light source disposed within the earbud 104 to illuminate the logo 248 during use of the system 100. The second body half 220 includes a hollow body with enclosures 250, 252 extending on opposing sides of a substantially circular ring 256 (see, e.g., FIG. 20). The enclosure 250 can receive therein the driver mount 228, and the enclosure 252 can receive therein the acoustic filter 230. The ear tip 222 (or rear cap) can be engaged with the second body half 220 and is configured to be placed within the ear of the user.

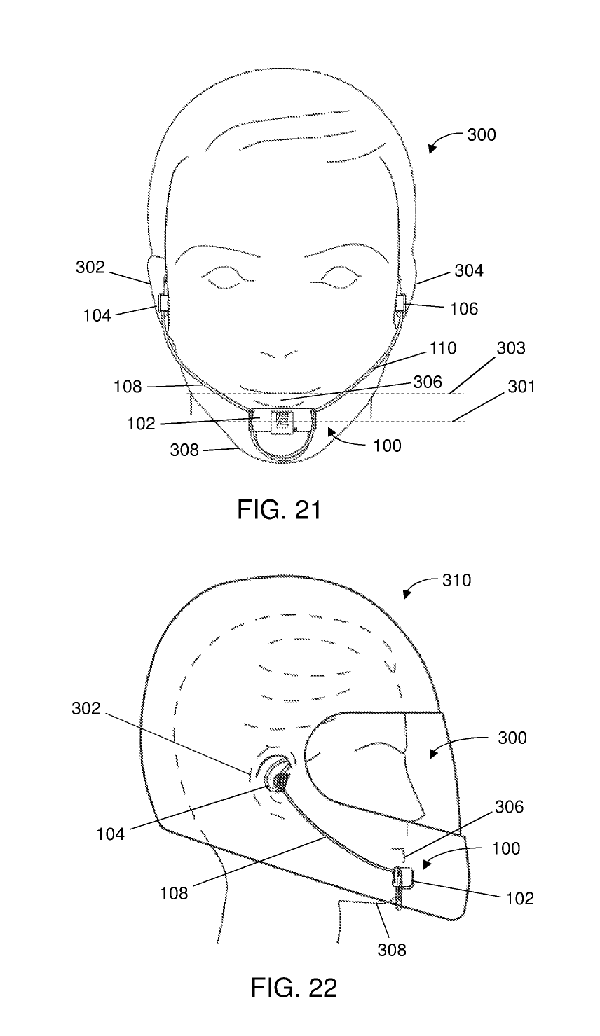

FIGS. 21-25 show different views of the system 100 worn by the user 300. In FIG. 21, the earbuds 104, 106 are inserted into the respective ears 302, 304 of the user 300. The user 300 has a lower lip 306 and a chin 308 disposed below the lower lip 306. The microphone assembly 102 can be positioned against the chin 308 and immediately below the lower lip 306. Particularly, the microphone assembly 102 can extend along a lateral plane 301 that is substantially parallel to a lateral plane 303 of the mouth of the user (e.g., substantially parallel to horizontal). The lower lip 306 can help in maintaining the position of the microphone assembly 102 on the chin 308. As noted above, the length of the wires 108, 110 between the earbuds 104, 106 and the microphone assembly 102 can be adjusted to achieve the desired position of the microphone assembly 102.

As can be seen from FIG. 21, the earbuds 104, 106 are disposed within the lateral planes defined by the ears 302, 304. FIG. 22 shows the user 300 with the system 100 and a helmet 310 positioned over the head of the user 300. The position of the microphone assembly 102 below the lower lip 306 and at the chin 308 level reduces interference between the helmet 310 and the microphone assembly 102, while positioning the microphone assembly 102 in a place where words spoken by the user 300 can be easily detected. The position of the microphone assembly 102 within the area defined by the helmet 310 also reduces wind capable of reaching the microphone assembly 102, reducing the amount of wind noise captured by the microphone assembly 102. The system 100 can therefore be worn comfortably by the user 300 while wearing a helmet 310, and improves overall sound quality of the microphone assembly 102.

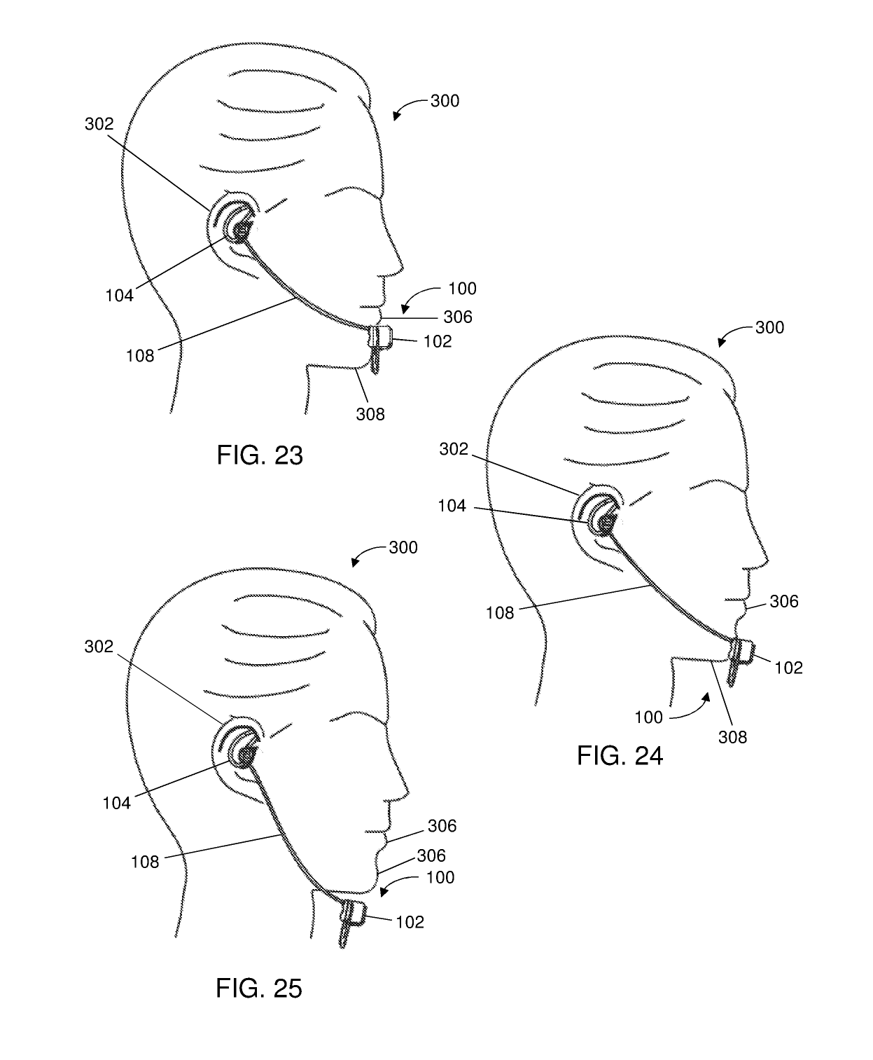

FIGS. 23-25 show different positions in which the microphone assembly 102 can be worn by the user 300. In FIG. 23, the microphone assembly 102 can be worn at the upper chin 308 level of the user 300 (e.g., immediately below the lower lip 306). In FIG. 24, the microphone assembly 102 can be worn at the lower chin 308 level of the user 300 (e.g., spaced from the lower lip 306, but at the front surface of the chin 308). In FIG. 25, the microphone assembly 102 can be worn below the chin 308 level of the user 300 (e.g., hanging below the lower surface of the chin 308).

In each configuration, the position of the microphone assembly 102 can be adjusted by regulating the length of the wires 108, 110 between the earbuds 104, 106 and the microphone assembly 102. The wires 108, 110 therefore elevate or suspend the microphone assembly 102 between the earbuds 104, 106. The insertion of the wires 108, 110 into the top corners of the microphone assembly 102 at the angles of the openings 166, 168 can generate forces that maintain the rear surface 122 of the microphone assembly 102 against the skin of the user and prevent the microphone assembly 102 for twisting or turning.

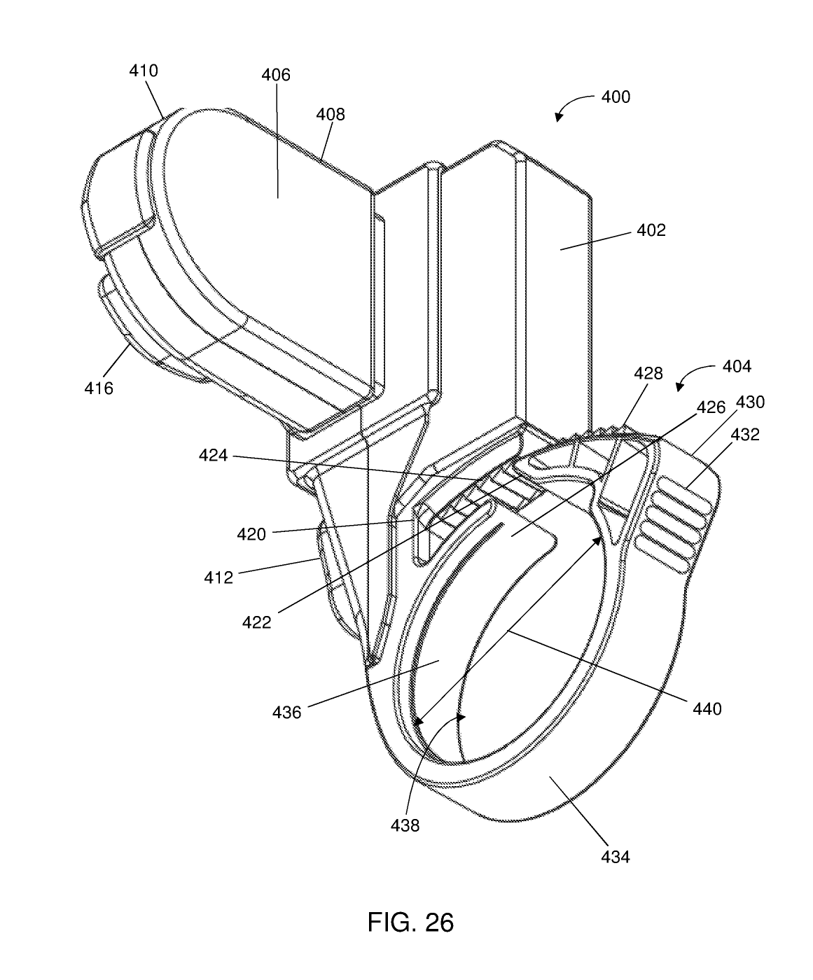

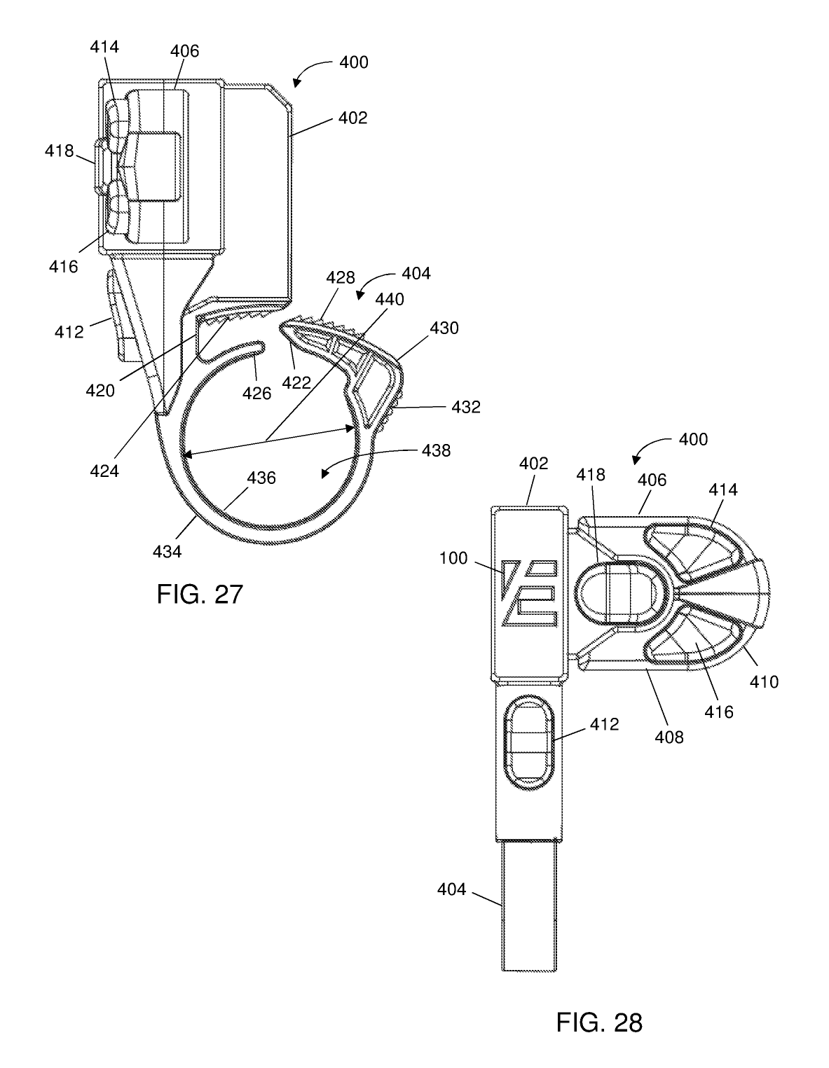

FIGS. 26-28 are perspective, side and front views of an exemplary controller 400 of the system 100. The controller 400 can be communicatively coupled (e.g., via Bluetooth) to the microphone assembly 102, allowing for the user 300 to regulate operation of the system 100 by the actuators on the microphone assembly 102 and the controller 400. In some embodiments, the controller 400 can be directly coupled to a mobile device or any Bluetooth enabled device. If connected to a Bluetooth enabled device, the controller 400 can provide the user with access to hands-free calling and/or media controls. The controller 400 includes a main body section 402 extending substantially in-line with (or along the same plane) as a ratchet locking mechanism 404. The controller 400 includes a second body section 406 extending substantially perpendicularly from the main body section 402.

In some embodiments, the main body section 402 can define a substantially cylindrical block and can house therein a plurality of electrical and communication components for operating the controller 400. In some embodiments, the second body section 406 can comprise a linear or cylindrical block section 408 and a rounded or semicircular end section 410. The main body section 402 can comprise a single actuator 412 (e.g., button) at the front surface of the controller 400. The actuator 412 can be used to regulate push-to-talk, start call, and/or end call functionality of the system 100. The second body section 406 can comprise three actuators 414-418 (e.g., buttons) disposed on the front surface of the second body section 406, and radially offset from each other.

In some embodiments, depressing the actuator 414 can be used to increase the volume of audio in the earbuds 104, 106. In some embodiments, holding the actuator 414 depressed can transition the audio to the next song in a playlist. In some embodiments, depressing the actuator 416 can be used to decrease the volume of audio in the earbuds 104, 106. In some embodiments, the actuator 418 can be used to play/pause the audio in the earbuds 104, 106. The large size of the actuators 414-418 provides for convenient control of the system 100 while participating in an activity, and offers the ability to use tactile recognition for operating the system 100 without looking at the controller 400.

The locking mechanism 404 includes a female section 420 formed at the bottom of the main body section 404, and a tapered male section 422 configured to releasably engage with the female section 420. The female section 420 includes a U-shaped opening configured to receive the male section 422. A top, inner surface of the female section 420 includes one or more teeth 424, and the bottom surface of the female section 420 includes a curved, substantially smooth extension 426. The male section 422 includes teeth 428 on an upper, outer surface. The teeth 428 face in the opposing direction from the teeth 424, and are configured to engage with the teeth 424 to secure the male section 422 within the female section 420.

The male section 422 extends into an arm 430 defining a substantially triangular configuration. The arm 430 therefore includes the male section 422 ending at a tapered point to be inserted into the female section 420, and also includes a handle area having a textured surface or protrusions 432 to assist in operating the locking mechanism 404. In operation, the user can impart force on the arm 430 to push the male section 422 into the female section 420. The teeth 424, 428 engage to secure the female and male sections 420, 422. To release the female and male sections 420, 422, force can be imparted on the arm 430 to slide the arm 430 laterally (e.g., sideways in a direction perpendicular to the main body section 402) until the teeth 424, 428 separate. Engagement and disengagement of the locking mechanism 404 relative to, e.g., handlebars of a motorcycle, can be performed quickly without the need for additional fastening elements.

The arm 430 extends into a substantially circular body 434 of the locking mechanism 404. The shape of the body 434 is selected such that the controller 400 can be secured to any cylindrical or tubular structure. The body 434 connects the arm 430 associated with the male section 422 to the female section 420, allowing the male section 422 to be flexed away from the female section 420 to position the locking mechanism 404 around the desired structure. Thus, prior to engagement, the male section 422 can be flexed away from the female section 420.

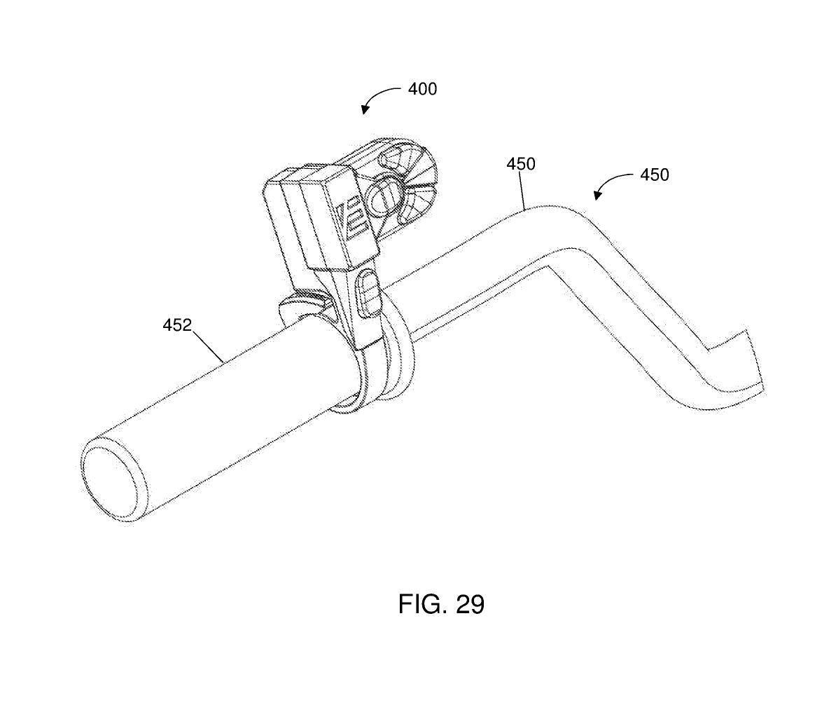

The inner surface 436 of the body 434 defines a substantially circular configuration extending from the extension 426 of the female section 420 to the inner or bottom surface of the arm 430 and the male section 422. The inner surface 436 forms a passage 438 capable of receiving a tubular structure. The inner surface 436 defines a diameter 440 that can be adjusted based on the depth to which the male section 422 is inserted into the female section 420. The locking mechanism 404 is therefore capable of being positioned and secured over handlebars of different sizes. As an example, FIG. 29 shows the controller 400 secured around the handle 452 of an exemplary handlebar 450 for a motorcycle. It should be understood that the controller 400 can be secured around either the handle 452 or the frame 454 of the handlebar 450.

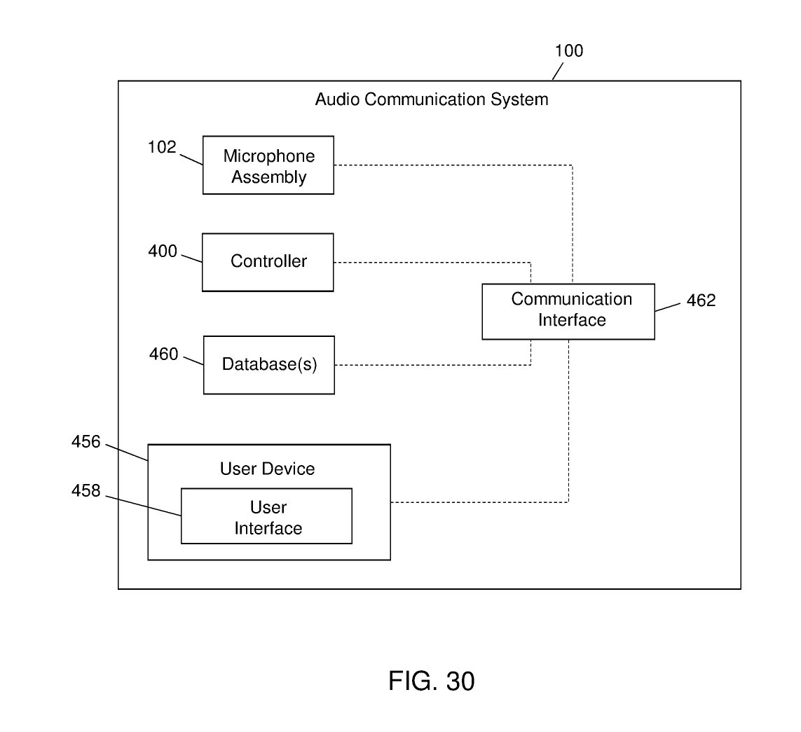

FIG. 30 is a block diagram of the exemplary audio communication system 100. As noted above, the system 100 includes the microphone assembly 102 and the controller 400. The system 100 can comprise a user device 456 (e.g., a mobile device) having a user interface 458, and one or more databases 460 with information associated with the user. In some embodiments, the databases 460 can electronically store data corresponding with, e.g., music on the user device 456, contacts available to call from the user device 456, contacts participating in the system 100, combinations thereof, or the like. In some embodiments, the databases 460 can be part of the user device 456. The microphone assembly 102, controller 400, databases 460, and user device 456 can be in communication with each other via a communication interface 462 (e.g., a wireless interface such as Bluetooth).

In operation, the system 100 can be used to listen to music on the user device 456. The system 100 can also be used for telephone conversations with contacts of the user. In some embodiments, the user can select a single contact from a contact list on the user device 456 to initiate a telephone conversation. In some embodiments, non-transitory computer-readable medium storing instructions for operating one or more components of the system 100 can be stored on the user device 456 and can be used to initiate calls with one or more other users of the system 100. For example, the instructions can be stored as a software application on the user device 456.

In such operation, the user can open the application on the user device 456. Via the communication interface 462 (and/or a global positioning system), the user device 456 can scan the surrounding environment and detect/identify other users (e.g., user devices) nearby who are also participating in the system 100. The detected surrounding users can be output to the user in the form of a list on the user interface 458. In some embodiments, the user can actuate a “Start Call” button on the user device 456 to initiate a group telephone call with all detected surrounding users. In some embodiments, the user can select the desired users from the detected surrounding users list, and actuate a “Start Call” button on the user device 456 to initiate a group call with only the selected users.

In some embodiments, upon actuating the “Start Call” button, the user device 456 can output a prompt requesting confirming from the user that a call with the listed users is desired. Upon receiving confirmation from the user, invitations to join the call can be electronically transmitted to the selected users. The users who receive the invitation can either join the call or dismiss the invitation. Once one of the invitees accepts the invitation to join the call, the group call can be initiated and each accepting user can be added as they confirm via their user interfaces. A group communication (e.g., voice over Internet Protocol (VOIP), telephone call, or the like) can therefore be easily initiated via the user device 456.

Traditionally, such group communication would involve selecting one individual before starting the call and subsequently adding more individuals to the call, or selecting individuals from a list of contacts before starting the call. Such action can be time consuming, especially if a desired contact is not in the user's contact list. The exemplary “nearby call” system for initiating a group communication with surrounding users can be useful if a group of riders, skiers, or the like, meet before an activity is started. The exemplary system allows for efficient setup and removes the need to add new contacts or browse through a contact list, saving time and effort by reducing the calling feature to a single button click.

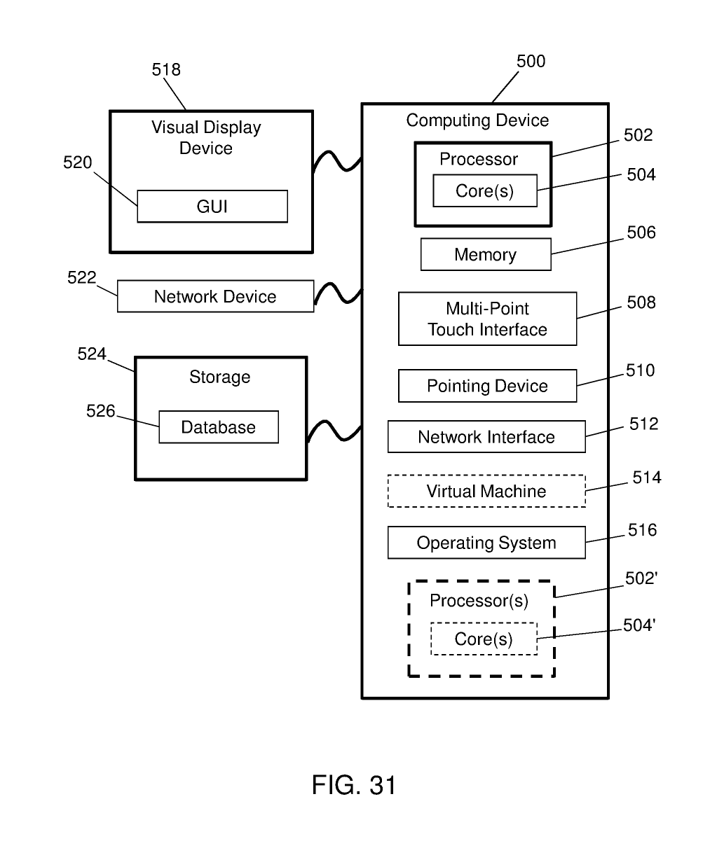

FIG. 31 is a block diagram of a computing device 500 in accordance with exemplary embodiments. The computing device 500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 506 included in the computing device 500 may store computer-readable and computer-executable instructions or software for implementing exemplary embodiments of the present disclosure (e.g., instructions for controlling the microphone assembly, instructions for controlling the user device, instructions for controlling the controller, combinations thereof, or the like). The computing device 500 also includes configurable and/or programmable processor 502 and associated core 504, and optionally, one or more additional configurable and/or programmable processor(s) 502′ and associated core(s) 504′ (for example, in the case of computer systems having multiple processors/cores), for executing computer-readable and computer-executable instructions or software stored in the memory 506 and other programs for controlling system hardware. Processor 502 and processor(s) 502′ may each be a single core processor or multiple core (504 and 504′) processor.

Virtualization may be employed in the computing device 500 so that infrastructure and resources in the computing device 500 may be shared dynamically. A virtual machine 514 may be provided to handle a process running on multiple processors so that the process appears to be using only one computing resource rather than multiple computing resources. Multiple virtual machines may also be used with one processor. Memory 506 may comprise a computer system memory or random access memory, such as DRAM, SRAM, EDO RAM, and the like. Memory 506 may comprise other types of memory as well, or combinations thereof.

A user may interact with the computing device 500 through a visual display device 518 (e.g., a personal computer, a mobile smart device, or the like), such as a computer monitor, which may display one or more user interfaces 320 (e.g., user interface 458) that may be provided in accordance with exemplary embodiments. The computing device 500 may comprise other I/O devices for receiving input from a user, for example, a keyboard or any suitable multi-point touch interface 508, a pointing device 510 (e.g., a mouse), a touch screen, or the like. The keyboard 508 and the pointing device 510 may be coupled to the visual display device 518. The computing device 500 may comprise other suitable conventional I/O peripherals.

The computing device 500 may also comprise one or more storage devices 524, such as a hard-drive, CD-ROM, or other computer readable media, for storing data and computer-readable instructions and/or software that implement one or more portions of the system 100, such as the microphone assembly, the controller, the user device, or the like. Exemplary storage device 524 may also store one or more databases 526 for storing any suitable information required to implement exemplary embodiments. For example, exemplary storage device 524 can store one or more databases 526 for storing information, such as data relating to the contacts of the user, music of the user, or the like, and computer-readable instructions and/or software that implement exemplary embodiments described herein. The databases 526 may be updated by manually or automatically at any suitable time to add, delete, and/or update one or more items in the databases.

The computing device 500 can comprise a network interface 512 configured to interface via one or more network devices 522 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 512 may comprise a built-in network adapter, network interface card, PCMCIA network card, card bus network adapter, wireless network adapter, USB network adapter, modem or any other device suitable for interfacing the computing device 500 to any type of network capable of communication and performing the operations described herein. Moreover, the computing device 500 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 500 may run an operating system 516, such as versions of the Microsoft® Windows® operating systems, the different releases of the Unix and Linux operating systems, versions of the MacOS® for Macintosh computers, embedded operating systems, real-time operating systems, open source operating systems, proprietary operating systems, or other operating systems capable of running on the computing device and performing the operations described herein. In exemplary embodiments, the operating system 516 may be run in native mode or emulated mode. In an exemplary embodiment, the operating system 516 may be run on one or more cloud machine instances.

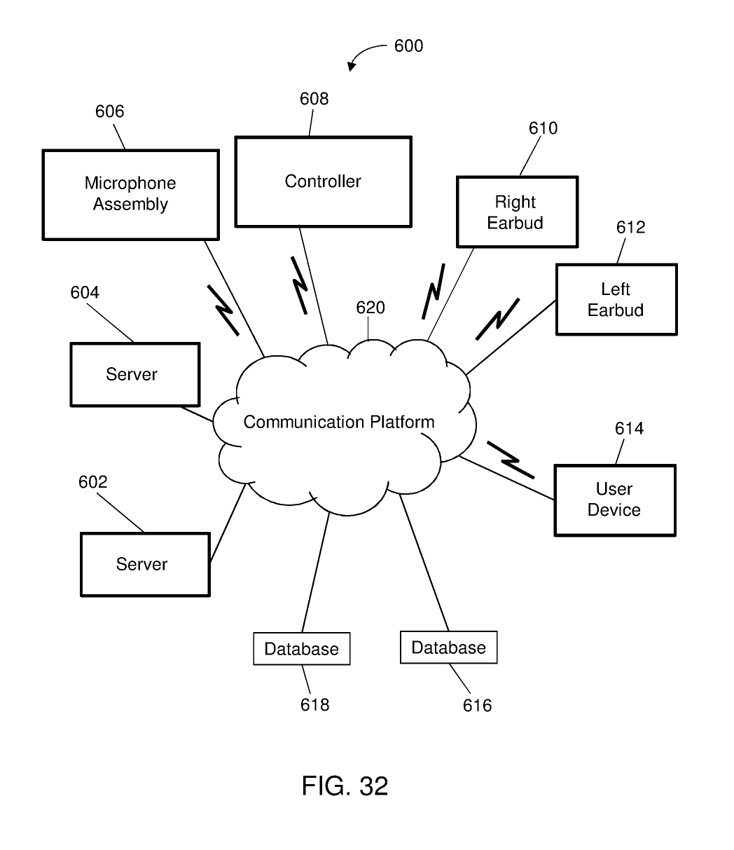

FIG. 32 is a block diagram of an exemplary audio communication system environment 600 in accordance with exemplary embodiments of the present disclosure. The environment 600 can comprise servers 602, 604 operatively coupled to microphone assembly 606, controller 608, optionally right and left earbuds 610, 612, and user device 614, via a communication platform 620, which can be any network over which information can be transmitted between devices communicatively coupled to the network. For example, the communication platform 620 can be Bluetooth, the Internet, Intranet, virtual private network (VPN), wide area network (WAN), local area network (LAN), and the like. In an embodiment, the communication platform 620 can be part of a cloud environment.

The environment 600 can comprise repositories or databases 616, 618, which can be operatively coupled to the servers 602, 604, as well as to the microphone assembly 606, controller 608, optionally right and left earbuds 610, 612, and user device 614, via the communications platform 620. In exemplary embodiments, the servers 602, 604, microphone assembly 606, controller 608, and user device 614 can be implemented as computing devices (e.g., computing device 500). Those skilled in the art will recognize that the databases 616, 618 can be incorporated into one or more of the servers 602, 604 such that one or more of the servers 602, 604 can comprise databases 616, 618.

In an embodiment, the databases 616, 618 can store contact information and music information. In an embodiment, embodiments of the servers 602, 604 can be configured to implement one or more portions of the system 100. For example, server 602 can be configured to implement one or more portions of the microphone assembly, the controller, and/or the user device.

While exemplary embodiments have been described herein, it is expressly noted that these embodiments should not be construed as limiting, but rather that additions and modifications to what is expressly described herein also are included within the scope of the present disclosure. Moreover, it is to be understood that the features of the various embodiments described herein are not mutually exclusive and can exist in various combinations and permutations, even if such combinations or permutations are not made express herein, without departing from the spirit and scope of the present disclosure.

1. A microphone assembly, comprising:
a body comprising a central section with a front surface and a rear surface;
a first wing extending from the central section on one side of the body;
a second wing extending from the central section on an opposing side of the body; and
a microphone disposed at the rear surface of the central section,
wherein the microphone and the rear surface are configured to be positioned against or immediately adjacent to a facial structure of a user.

2. The microphone assembly of claim 1, wherein the facial structure of the user is a chin.

3. The microphone assembly of claim 1, comprising ribs protruding from the central section at the rear surface of the body and surrounding the microphone.

4. The microphone assembly of claim 3, wherein a protrusion height of the microphone from the rear surface of the central section is dimensioned equal to a protrusion height of the ribs protruding from the central section.

5. The microphone assembly of claim 3, wherein a protrusion height of the microphone from the rear surface of the central section is dimensioned smaller than a protrusion height of the ribs protruding from the central section.

6. The microphone assembly of claim 1, comprising an actuator assembly coupled to the front surface of the central section.

7. The microphone assembly of claim 6, wherein the actuator assembly comprises a first button extending around the front surface of the central section, around a bottom edge of the central section, and along a bottom surface of the central section.

8. The microphone assembly of claim 1, wherein the first and second wings each comprise an opening extending from a rear surface to a front surface of the respective first and second wings.

9. The microphone assembly of claim 8, wherein the first and second wings each comprise a groove connected to the respective opening and extending along the front surface of the first and second wings.

10. The microphone assembly of claim 9, wherein the first and second wings each comprise wire clips disposed on opposing sides of the groove and configured to detachably secure earbud wires.

11. A microphone assembly, comprising:
a body comprising a central section extending along a first plane;
a first wing extending from the central section on one side of the body, the first wing extending along a second plane radially offset from the first plane by a first angle;
a second wing extending from the central section on an opposing side of the body, the second wing extending along a third plane radially offset from the first plane by a second angle; and
a microphone disposed on the body.

12. The microphone assembly of claim 11, wherein the first angle and the second angle are between about 15 degrees and about 60 degrees.

13. The microphone assembly of claim 11, wherein the first angle and the second angle are about 37 degrees.

14. The microphone assembly of claim 11, wherein the microphone is disposed at a rear surface of the body and configured to be positioned against or immediately adjacent to a facial structure of a user.

15. The microphone assembly of claim 11, wherein the microphone is disposed at a top edge of the body and configured to be spaced from a facial structure of a user.

16. The microphone assembly of claim 11, comprising ribs protruding from the central section at the rear surface of the body and surrounding the microphone.

17. An audio communication system, comprising:
a first earbud connected to a first wire;
a second earbud connected to a second wire; and
a microphone assembly connected to the first and second wires, the first and second wires capable of suspending the microphone assembly between the first and second earbuds at chin-level of a user.

18. The audio communication system of claim 17, wherein the microphone assembly is slidably engaged with the first and second wires.

19. The audio communication system of claim 17, wherein the first and second wires are configured to suspend the microphone assembly along a lateral plane parallel to a lateral plane of a mouth of the user.

20. The audio communication system of claim 17, comprising a controller communicatively coupled to the microphone assembly, the controller comprising a ratchet locking mechanism for detachably locking the controller to a handlebar.
